(19) United States
(12) Patent Application Publication
(10) Pub. No.: US 2009/0036543 A1
(43) Pub. Date: Feb. 5, 2009

(54) Preservatives

(76) Inventors: Werner Holzl, Eschentzwiller (FR); Andrea Preuss, Basel (CH)

Correspondence Address: JoAnn Villamizar;Patent Department, 540 White Plains Road, P.O.Box 2005, Tarrytown, NY, 10591-9005, US

(21) Appl. No.: 11/988,589

(22) PCT Filed: Jul. 5, 2006
(86) PCT No.: PCT/EP2006/063896

§ 371 Date: Jan. 10, 2008

(30) Foreign Application Priority Data
Jul. 15, 2005 (EP) 05106510.0

(51) Int. Cl. A01N 31/08; A01N 31/16; A01P 1/00

(52) U.S. Cl. 514/721; 514/736

(57) ABSTRACT

The present invention relates to the use of compounds of the formula (1) wherein all substitutents have the meanings as defined in claim 1 as preservatives in personal care, pharmaceutical and household; the preservatives can also be used as in-can preservatives.

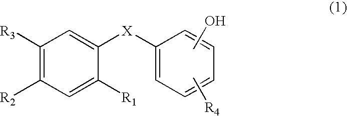

The present invention relates to the use of specific aromatic compounds as preservatives.

The present invention provides the use of the compounds of the following formula (1)

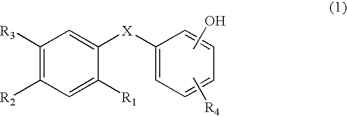

wherein

X is —CH₂— or —O—;

R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;

R₃ is hydrogen, C₁-C₂₀alkyl, C₁-C₆alkylcarbonyl or C₁-C₂₀alkoxy; and

R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;

as preservatives.

These preservatives are preferably used in cosmetic and/or pharmaceutical formulations. Furthermore these preservatives can also be used as in-can preservatives for technical applications.

In contrast to the disinfection agents, which destroys the microorganism very fast, a preservative has to have an effect over a longer period of time. Preservative have a so called microbiostatic effect.

C₁-C₂₀alkyl is straight-chain or branched alkyl radicals such as methyl, ethyl, n-propyl, isopropyl, n-butyl, sec-butyl, tert-butyl, pentyl, iso-pentyl, tert-pentyl, hexyl, cyclohexyl, heptyl, octyl, isooctyl, nonyl or decyl and the like.

C₁-C₂₀alkoxy is straight-chain or branched alkoxy radicals such as methoxy, ethoxy, n-propoxy, isopropoxy, n-butoxy, sec-butoxy, tert-butoxy, pentyloxy, iso-pentyloxy, tert-pentyloxy, heptyloxy, octyloxy, isooctyloxy, nonyloxy or decyloxy and the like.

C₁-C₆alkyl carbonyl is straight-chain or branched carbonyl radicals such as acetyl, propionyl, butyryl, isobutyryl, valeryl, isovaleryl or pivaloyl and the like.

Hydroxy substituted C₁-C₂₀alkyl is hydroxymethyl, hydroxyethyl, hydroxypropyl, hydroxybutyl, hydroxypentyl, hydroxyhexyl, hydroxyheptyl, hydroxyoctyl, hydroxynonyl or hydroxydecyl and the like.

A preferred embodiment of the present invention is the use of the compounds of formula (1), wherein

X is —CH₂— or —O—

R₁ and R₂ are independently of each other hydrogen, hydroxy, C₁-C₁₀alkyl, C₅-C₇cycloalkyl, C₁-C₄alkylcarbonyl, C₁-C₁₀alkoxy, phenyl or phenyl-C₁-C₃-alkyl;

R₃ is hydrogen, C₁-C₁₀alkyl, C₁-C₄alkylcarbonyl or C₁-C₁₀alkoxy;

R₄ is hydrogen, C₁-C₁₀alkyl, hydroxy substituted C₁-C₁₀alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

A more preferred embodiment of the present invention is the use of the compounds of formula (1),

wherein

X is —CH₂— or —O—

R₁ and R₂ are independently of each other hydrogen, hydroxy, C₁-C₄alkyl, C₅-C₇cycloalkyl, C₁-C₄alkylcarbonyl, C₁-C₄alkoxy, phenyl or phenyl-C₁-C₃-alkyl;

R₃ is hydrogen, C₁-C₄alkyl, C₁-C₄alkylcarbonyl or C₁-C₄alkoxy;

R₄ is hydrogen, C₁-C₄alkyl, hydroxy substituted C₁-C₄alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An interesting embodiment of the present invention is the use of the compounds of formula (1a),

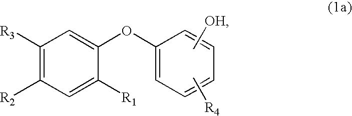

wherein

R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;

R₃ is hydrogen, C₁-C₂₀alkyl, C₁-C₆alkylcarbonyl or C₁-C₂₀alkoxy;

R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;

as preservatives.

A more interesting embodiment of the present invention is the use of the compounds of formula (1a),

wherein

R₁ and R₂ are independently of each other hydrogen, hydroxy, C₁-C₁₀alkyl, C₅-C₇cycloalkyl, C₁-C₄alkylcarbonyl, C₁-C₁₀alkoxy, phenyl or phenyl-C₁-C₃-alkyl;

R₃ is hydrogen, C₁-C₁₀alkyl, C₁-C₄alkylcarbonyl or C₁-C₁₀alkoxy;

R₄ is hydrogen, C₁-C₁₀alkyl, hydroxy substituted C₁-C₁₀alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An especially interesting embodiment of the present invention is the use of the compounds of formula (1a),

wherein

R₁ and R₂ are independently of each other hydrogen, hydroxy, C₁-C₄alkyl, C₅-C₇cycloalkyl, C₁-C₄alkylcarbonyl, C₁-C₄alkoxy, phenyl or phenyl-C₁-C₃-alkyl;

R₃ is hydrogen, C₁-C₄alkyl, C₁-C₄alkylcarbonyl or C₁-C₄alkoxy;

R₄ is hydrogen, C₁-C₄alkyl, hydroxy substituted C₁-C₄alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An interesting embodiment of the present invention is the use of the compounds of formula (1b),

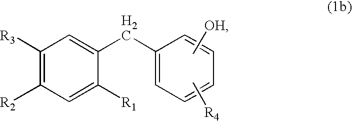

wherein

R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;

R₃ is hydrogen, C₁-C₂₀alkyl, C₁-C₆alkylcarbonyl or C₁-C₂₀alkoxy;

R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;

as preservatives.

A more interesting embodiment of the present invention is the use of the compounds of formula (1b),

wherein

R₁ and R₂ are independently of each other hydrogen, hydroxy, C₁-C₁₀alkyl, C₅-C₇cycloalkyl, C₁-C₄alkylcarbonyl, C₁-C₁₀alkoxy, phenyl or phenyl-C₁-C₃-alkyl;

R₃ is hydrogen, C₁-C₁₀alkyl, C₁-C₄alkylcarbonyl or C₁-C₁₀alkoxy;

R₄ is hydrogen, C₁-C₁₀alkyl, hydroxy substituted C₁-C₁₀alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An especially interesting embodiment of the present invention is the use of the compounds of formula (1b),

wherein

R₁ and R₂ are independently of each other hydrogen, hydroxy, C₁-C₄alkyl, C₅-C₇cycloalkyl, C₁-C₄alkylcarbonyl, C₁-C₄alkoxy, phenyl or phenyl-C₁-C₃-alkyl;

R₃ is hydrogen, C₁-C₄alkyl, C₁-C₄alkylcarbonyl or C₁-C₄alkoxy;

R₄ is hydrogen, C₁-C₄alkyl, hydroxy substituted C₁-C₄alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An interesting embodiment of the present invention is the use of the compounds of formula (1c),

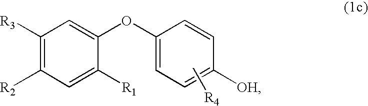

wherein

R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;

R₃ is hydrogen, C₁-C₂₀alkyl, C₁-C₆alkylcarbonyl or C₁-C₂₀alkoxy;

R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;

as preservatives.

A more interesting embodiment of the present invention is the use of the compounds of formula (1c),

wherein

R₁ and R₂ are independently of each other hydrogen, hydroxy, C₁-C₁₀alkyl, C₅-C₇cycloalkyl, C₁-C₄alkylcarbonyl, C₁-C₁₀alkoxy, phenyl or phenyl-C₁-C₃-alkyl;

R₃ is hydrogen, C₁-C₁₀alkyl, C₁-C₄alkylcarbonyl or C₁-C₁₀alkoxy;

R₄ is hydrogen, C₁-C₁₀alkyl, hydroxy substituted C₁-C₁₀alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An especially interesting embodiment of the present invention is the use of the compounds of formula (1c),

wherein

R₁ and R₂ are independently of each other hydrogen, hydroxy, C₁-C₄alkyl, C₅-C₇cycloalkyl, C₁-C₄alkylcarbonyl, C₁-C₄alkoxy, phenyl or phenyl-C₁-C₃-alkyl;

R₃ is hydrogen, C₁-C₄alkyl, C₁-C₄alkylcarbonyl or C₁-C₄alkoxy;

R₄ is hydrogen, C₁-C₄alkyl, hydroxy substituted C₁-C₄alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An interesting embodiment of the present invention is the use of the compounds of formula (1d),

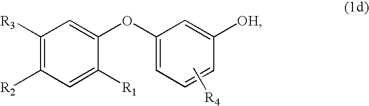

wherein

R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;

R₃ is hydrogen, C₁-C₂₀alkyl, C₁-C₆alkylcarbonyl or C₁-C₂₀alkoxy;

R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;

as preservatives.

A more interesting embodiment of the present invention is the use of the compounds of formula (1d),

wherein

R₁ and R₂ are independently of each other hydrogen, hydroxy, C₁-C₁₀alkyl, C₅-C₇cycloalkyl, C₁-C₄alkylcarbonyl, C₁-C₁₀alkoxy, phenyl or phenyl-C₁-C₃-alkyl;

R₃ is hydrogen, C₁-C₁₀alkyl, C₁-C₄alkylcarbonyl or C₁-C₁₀alkoxy;

R₄ is hydrogen, C₁-C₁₀alkyl, hydroxy substituted C₁-C₁₀alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An especially interesting embodiment of the present invention is the use of the compounds of formula (1d),

wherein

R₁ and R₂ are independently of each other hydrogen, hydroxy, C₁-C₄alkyl, C₅-C₇cycloalkyl, C₁-C₄alkylcarbonyl, C₁-C₄alkoxy, phenyl or phenyl-C₁-C₃-alkyl;

R₃ is hydrogen, C₁-C₄alkyl, C₁-C₄alkylcarbonyl or C₁-C₄alkoxy;

R₄ is hydrogen, C₁-C₄alkyl, hydroxy substituted C₁-C₄alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An interesting embodiment of the present invention is the use of the compounds of formula (1e),

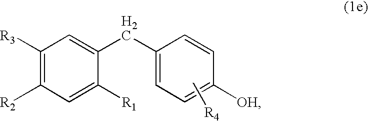

wherein

R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;

R₃ is hydrogen, C₁-C₂₀alkyl, C₁-C₆alkylcarbonyl or C₁-C₂₀alkoxy;

R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;

as preservatives.

A more interesting embodiment of the present invention is the use of the compounds of formula (1e),

wherein

R₁ and R₂ are independently of each other hydrogen, hydroxy, C₁-C₁₀alkyl, C₅-C₇cycloalkyl, C₁-C₄alkylcarbonyl, C₁-C₁₀alkoxy, phenyl or phenyl-C₁-C₃-alkyl;

R₃ is hydrogen, C₁-C₁₀alkyl, C₁-C₄alkylcarbonyl or C₁-C₁₀alkoxy;

R₄ is hydrogen, C₁-C₁₀alkyl, hydroxy substituted C₁-C₁₀alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An especially interesting embodiment of the present invention is the use of the compounds of formula (1e),

wherein

R₁ and R₂ are independently of each other hydrogen, hydroxy, C₁-C₄alkyl, C₅-C₇cycloalkyl, C₁-C₄alkylcarbonyl, C₁-C₄alkoxy, phenyl or phenyl-C₁-C₃-alkyl;

R₃ is hydrogen, C₁-C₄alkyl, C₁-C₄alkylcarbonyl or C₁-C₄alkoxy;

R₄ is hydrogen, C₁-C₄alkyl, hydroxy substituted C₁-C₄alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An interesting embodiment of the present invention is the use of the compounds of formula (1f),

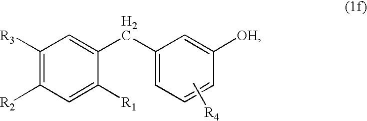

wherein

R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;

R₃ is hydrogen, C₁-C₂₀alkyl, C₁-C₆alkylcarbonyl or C₁-C₂₀alkoxy;

R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;

as preservatives.

A more interesting embodiment of the present invention is the use of the compounds of formula (1f),

wherein

R₁ and R₂ are independently of each other hydrogen, hydroxy, C₁-C₁₀alkyl, C₅-C₇cycloalkyl, C₁-C₄alkylcarbonyl, C₁-C₁₀alkoxy, phenyl or phenyl-C₁-C₃-alkyl;

R₃ is hydrogen, C₁-C₁₀alkyl, C₁-C₄alkylcarbonyl or C₁-C₁₀alkoxy;

R₄ is hydrogen, C₁-C₁₀alkyl, hydroxy substituted C₁-C₁₀alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

An especially interesting embodiment of the present invention is the use of the compounds of formula (1f),

wherein

R₁ and R₂ are independently of each other hydrogen, hydroxy, C₁-C₄alkyl, C₅-C₇cycloalkyl, C₁-C₄alkylcarbonyl, C₁-C₄alkoxy, phenyl or phenyl-C₁-C₃-alkyl;

R₃ is hydrogen, C₁-C₄alkyl, C₁-C₄alkylcarbonyl or C₁-C₄alkoxy;

R₄ is hydrogen, C₁-C₄alkyl, hydroxy substituted C₁-C₄alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl;

as preservatives.

Most important for the use as preservatives are the compound of formula (1g), (1h) and (1i)

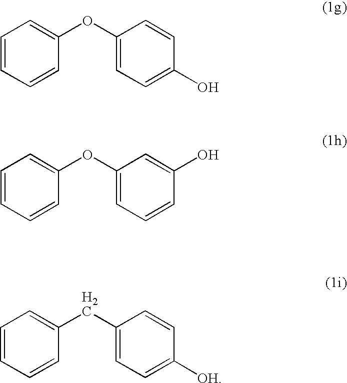

The compounds are known or can be produced in accordance to methods known in the prior art. Such a process of production is for example disclosed in EP 1053989.

The concentration of the preservative according to the present invention in a formulation can vary. Generally, the preseratives of the present invention can be incorporated in a commercial formulation at a concentration of between about 0.01 and about 5 weight percentage (wt-%), based on total formulation. More specifically, for cosmetic or pharmaceutical formulations, the amount of the present mixture need not exceed 1.0 wt-%; however, for industrial or household cleaners, up to 5 wt-% can be employed when desired.

An embodiment of the present invention is a personal care formulation comprising at least one compound of formula (1), (1a), (1b), (1c), (1d), (1e), (1f), (1g), (1h) and/or (1i), and cosmetically tolerable adjuvants.

A preferred embodiment of the present invention is a personal care formulation comprising
0.01 to 5 wt-% of at least one compound of formula (1), (1a), (1b), (1c), (1d), (1e), (1f), (1g), (1h) and/or (1i), and
95 to 99.99 wt-% of at least one cosmetically tolerable adjuvant.

Another embodiment of the present invention is a pharmaceutical formulation comprising at least one compound of formula (1), (1a), (1b), (1c), (1d), (1e), (1f), (1g), (1h) and/or (1i), and pharmaceutically tolerable adjuvants.

A preferred embodiment of the present invention is a pharmaceutical formulation comprising
0.01 to5wt-% of at least one compound of formula (1), (1a), (1b), (1c), (1d), (1e), (1f), (1g), (1h) and/or (1i), and
95 to 99.99 wt-% of at least one pharmaceutically tolerable adjuvant.

Another embodiment of the present invention is a household formulation comprising at least one compound of formula (1), (1a), (1b), (1c), (1d), (1e), (1f), (1g), (1h) and/or (1i), and adjuvants used in household formulations.

A preferred embodiment of the present invention is a pharmaceutical formulation comprising
0.01 to 5 wt-% of at least one compound of formula (1), (1a), (1b), (1c), (1d), (1e), (1f), (1g), (1h) and/or (1i), and
95 to 99.99 wt-% of at least one adjuvant used in household formulations.

The personal care preparation according to the invention may be formulated as a water-in-oil or oil-in-water emulsion, as an alcoholic or alcohol-containing formulation, as a vesicular dispersion of an ionic or non-ionic amphiphilic lipid, as a gel, a solid stick or as an aerosol formulation.

As a water-in-oil or oil-in-water emulsion, the cosmetically tolerable adjuvant contains preferably from 5 to 50 wt-% of an oily phase, from 5 to 20 wt-% of an emulsifier and from 30 to 90 wt-% of water, based on the the total weight of the emulsion. The oily phase may contain any oil suitable for cosmetic formulations, e.g. one or more hydrocarbon oils, a wax, a natural oil, a silicone oil, a fatty acid ester or a fatty alcohol. Preferred mono- or poly-ols are ethanol, isopropanol, propylene glycol, hexylene glycol, glycerol and sorbitol.

Cosmetic formulations according to the invention are used in a variety of fields. Especially the following preparations, for example, come into consideration:

skin-care preparations, e.g. skin-washing and cleansing preparations in the form of tablet-form or liquid soaps, synthetic detergents or washing pastes;

bath preparations, e.g. liquid (foam baths, milks, shower preparations) or solid bath preparations, e.g. bath cubes and bath salts;

skin-care preparations, e.g. skin emulsions, multi-emulsions or skin oils;

cosmetic personal care preparations, e.g. facial make-up in the form of day creams or powder creams, face powder (loose or pressed), rouge or cream make-up, eye-care preparations, e.g. eyeshadow preparations, mascara, eyeliner, eye creams or eye-fix creams; lip-care preparations, e.g. lipsticks, lip gloss, lip contour pencils, nail-care preparations, such as nail varnish, nail varnish removers, nail hardeners or cuticle removers;

intimate hygiene preparations, e.g. intimate washing lotions or intimate sprays;

foot-care preparations, e.g. foot baths, foot powders, foot creams or foot balsams, special deodorants and antiperspirants or callus-removing preparations;

light-protective preparations, such as sun milks, lotions, creams and oils, sun blocks or tropicals, pre-tanning preparations or after-sun preparations;

skin-tanning preparations, e.g. self-tanning creams;

depigmenting preparations, e.g. preparations for bleaching the skin or skin-lightening preparations;

insect-repellents, e.g. insect-repellent oils, lotions, sprays or sticks;

deodorants, such as deodorant sprays, pump-action sprays, deodorant gels, sticks or roll-ons;

antiperspirants, e.g. antiperspirant sticks, creams or roll-ons;

preparations for cleansing and caring for blemished skin, e.g. synthetic detergents (solid or liquid), peeling or scrub preparations or peeling masks;

hair-removal preparations in chemical form (depilation), e.g. hair-removing powders, liquid hair-removing preparations, cream- or paste-form hair-removing preparations, hair-removing preparations in gel form or aerosol foams;

shaving preparations, e.g. shaving soap, foaming shaving creams, non-foaming shaving creams, foams and gels, preshave preparations for dry shaving, aftershaves or aftershave lotions;

fragrance preparations, e.g. fragrances (eau de Cologne, eau de toilette, eau de parfum, parfum de toilette, perfume), perfume oils or cream perfumes;

dental-care, denture-care and mouth-care preparations, e.g. toothpastes, gel toothpastes, tooth powders, mouthwash concentrates, anti-plaque mouthwashes, denture cleaners or denture fixatives;

cosmetic hair-treatment preparations, e.g. hair-washing preparations in the form of shampoos, hair conditioners, hair-care preparations, e.g. pretreatment preparations, hair tonics, styling creams, styling gels, pomades, hair rinses, treatment packs, intensive hair treatments, hair-structuring preparations, e.g. hair-waving preparations for permanent waves (hot wave, mild wave, cold wave), hair-straightening preparations, liquid hair-setting preparations, foams, hairsprays, bleaching preparations, e.g. hydrogen peroxide solutions, lightening shampoos, bleaching creams, bleaching powders, bleaching pastes or oils, temporary, semi-permanent or permanent hair colorants, preparations containing self-oxidising dyes, or natural hair colorants, such as henna or camomile.

A soap has, for example, the following composition:

| | |
|---|---|
| 0.01 to 5 wt-% | of at least one compound of formula (1), (1a), |
| | (1b), (1c), (1d), (1e), (1f), (1g), (1h) and/or (1i), |
| 0.3 to 1 wt-% | of titanium dioxide, |
| 1 to 10 wt-% | of stearic acid, |
| 0 to 10 wt-% | of at least one auxiliary, and |
| ad 100% | of a soap base, e.g. the sodium salts of tallow |
| | fatty acid and coconut fatty acid or glycerol. |

A shampoo has, for example, the following composition:

| | |
|---|---|
| 0.01 to 5 wt-% | of at least one compound of formula (1), (1a), |
| | (1b), (1c), (1d), (1e), (1f), (1g), (1h) and/or (1i), |
| 12.0 wt-% | of sodium laureth-2-sulfate, |
| 4.0 wt-% | of cocamidopropyl betaine, |
| 3.0 wt-% | of NaCl, |
| 0 to 10 wt-% | of at least one auxiliary, and |
| ad 100 wt-% | of water. |

A deodorant has, for example, the following composition:

| | |
|---|---|
| 0.01 to 5 wt-% | of at least one compound of formula (1), (1a), |
| | (1b), (1c), (1d), (1e), (1f), (1g), (1h) and/or (1i), |
| 60 wt-% | of ethanol, |
| 0.3 wt-% | of perfume oil, |
| 0 to 10 wt-% | of at least one auxiliary, and |
| ad 100 wt-% | of water. |

All wt-%'s are based on the total weight of the compositions.

The invention relates also to an oral composition, comprising from 0.01 to 15 wt-%, based on the total weight of the composition, of at least one compound of formula (1), (1a), (1b), (1c), (1d), (1e), (1f), (1g), (1h) and/or (1i), and orally tolerable adjuvants.

Example of an oral composition:

| | |
|---|---|
| 10 wt-% | of sorbitol |
| 10 wt-% | of glycerol |
| 15 wt-% | of ethanol |
| 15 wt-% | of propylene glycol |
| 0.5 wt-% | of sodium lauryl sulfate |
| 0.25 wt-% | of sodium methylcocyl taurate |
| 0.25 wt-% | of polyoxypropylene/polyoxyethylene block copolymer |
| 0.10 wt-% | of peppermint flavouring |
| 0.1 to 0.5 wt-% | of at least one compound of formula (1), (1a), (1b), |
| | (1c), (1d), (1e), (1f), (1g), (1h) and/or (1i), and |
| 48.6 wt-% | of water. |

The oral composition according to the invention may be, for example, in the form of a gel, a paste, a cream or an aqueous preparation (mouthwash).

The oral composition according to the invention may also comprise compounds that release fluoride ions which are effective against the formation of caries, for example inorganic fluoride salts, e.g. sodium, potassium, ammonium or calcium fluoride, or organic fluoride salts, e.g. amine fluorides, which are known under the trade name Olafluor.

The compounds of formula (1), (1a), (1b), (1c), (1d), (1e), (1f), (1g), (1h) and/or (1i) can be used also in household and all-purpose cleaners for cleaning hard surfaces. A cleaning preparation has, for example, the following composition:

| | |
|---|---|
| 0.01 to 5 wt-% | of at least one compound of formula (1), (1a), (1b), |
| | (1c), (1d), (1e), (1f), (1g), (1h) and/or (1i), and |
| 3.0 wt-% | octyl alcohol 4EO |
| 1.3 wt-% | fatty alcohol C₈-C₁₀polyglucoside |
| 3.0 wt-% | isopropanol |
| 0 to 5 wt-% | of auxiliaries, |
| ad 100 wt-% | water. |

Also possible, in addition to the preservation of cosmetic and household products, is the preservation of technical products (in-can preservation), such as in paper treatment, especially in paper treatment liquors, printing thickeners of starch or of cellulose derivatives, surface-coatings and paints.

The cosmetic or pharmaceutical compositions/preparations according to the invention may also comprise one or one more additional compounds (auxiliary) as described below.

### Fatty Alcohols

Guerbet alcohols based on fatty alcohols having from 6 to 18, preferably from 8 to 10, carbon atoms, including cetyl alcohol, stearyl alcohol, cetearyl alcohol, oleyl alcohol, octyidodecanol, benzoates of C₁₂—C₁₅ alcohols, acetylated lanolin alcohol etc.

### Esters of Fatty Acids

Esters of linear C₆—C₂₄ fatty acids with linear C₃-C₂₄ alcohols, esters of branched C₆—C₁₃-carboxylic acids with linear C₆—C₂₄ fatty alcohols, esters of linear C₆—C₂₄ fatty acids with branched alcohols, especially 2-ethylhexanol, esters of hydroxycarboxylic acids with linear or branched C₆—C₂₂ fatty alcohols, especially dioctyl malates, esters of linear and/or branched fatty acids with polyhydric alcohols (for example propylene glycol, dimer diol or trimer triol) and/or Guerbet alcohols, for example caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselinic acid, linoleic acid, linolenic acid, elaeostearic acid, arachidic acid, gadoleic acid, behenic acid and erucic acid and technical-grade mixtures thereof (obtained, for example, in the pressure removal of natural fats and oils, in the reduction of aldehydes from Roelen's oxosynthesis or in the dimerisation of unsaturated fatty acids) with alcohols, for example, isopropyl alcohol, caproic alcohol, capryl alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linoyl alcohol, linolenyl alcohol, elaeostearyl alcohol, arachidyl alcohol, gadoleyl alcohol, behenyl alcohol, erucyl alcohol and brassidyl alcohol and technical-grade mixtures thereof (obtained, for example, in the high-pressure hydrogenation of technical-grade methyl esters based on fats and oils or aldehydes from Roelen's oxosynthesis and as monomer fractions in the dimerisation of unsaturated fatty alcohols).

Examples of such ester oils are isopropyl myristate, isopropyl palmitate, isopropyl stearate, isopropyl isostearate, isopropyl oleate, n-butyl stearate, n-hexyl laurate, n-decyl oleate, isooctyl stearate, isononyl stearate, isononyl isononanoate, 2-ethylhexyl palmitate, 2-hexyl laurate, 2-hexyldecyl stearate, 2-octyidodecyl palmitate, oleyl oleate, oleyl erucate, erucyl oleate, erucyl erucate, cetearyl octanoate, cetyl palmitate, cetyl stearate, cetyl oleate, cetyl behenate, cetyl acetate, myristyl myristate, myristyl behenate, myristyl oleate, myristyl stearate, myristyl palmitate, myristyl lactate, propylene glycol dicaprylate/caprate, stearyl heptanoate, diisostearyl malate, octyl hydroxystearate etc.

### Other Adjuvants

Diethylhexyl 2,6-naphthalate, di-n-butyl adipate, di(2-ethylhexyl) adipate, di(2-ethylhexyl) succinate and diisotridecyl acetate, and also diol esters, such as ethylene glycol dioleate, ethylene glycol diisotridecanoate, propylene glycol di(2-ethylhexanoate), propylene glycol diisostearate, propylene glycol dipelargonate, butanediol diisostearate and neopentyl glycol dicaprylate. Esters of C₆—C₂₄ fatty alcohols and/or Guerbet alcohols with aromatic carboxylic acids, saturated and/or unsaturated, especially benzoic acid, esters of C₂-C₁₂dicarboxylic acids with linear or branched alcohols having from 1 to 22 carbon atoms or polyols having from 2 to 10 carbon atoms and from 2 to 6 hydroxy groups, or iminodisuccinic acid and iminodisuccinic acid salts [CAS 7408-20-0] or latex particles.

Natural or Synthetic Triglycerides, including Glyceryl Esters and Derivatives

Di- or tri-glycerides, based on C₆—C₁₈ fatty acids, modified by reaction with other alcohols (caprylic/capric triglyceride, wheatgerm glycerides, etc.). Fatty acid esters of polyglycerol (polyglyceryl-n such as polyglyceryl-4 caprate, polyglyceryl-2 isostearate, etc.) or castor oil, hydrogenated vegetable oil, sweet almond oil, wheatgerm oil, sesame oil, hydrogenated cottonseed oil, coconut oil, avocado oil, corn oil, hydrogenated castor oil, shea butter, cocoa butter, soybean oil, mink oil, sunflower oil, safflower oil, macadamia nut oil, olive oil, hydrogenated tallow, apricot kernel oil, hazelnut oil, borage oil etc.

Waxes, including esters of long-chain acids and alcohols as well as compounds having wax-like properties, e.g. carnauba wax, beeswax (white or yellow), lanolin wax, candelilla wax, ozokerite, japan wax, paraffin wax, microcrystalline wax, ceresin, cetearyl ester wax, synthetic beeswax etc. Also, hydrophilic waxes such as cetearyl alcohol or partial glycerides.

### Pearlescent Waxes:

Alkylene glycol esters, especially ethylene glycol distearate; fatty acid alkanolamides, especially coco fatty acid diethanolamide; partial glycerides, especially stearic acid monoglyceride; esters of polyvalent, unsubstituted or hydroxy-substituted carboxylic acids with fatty alcohols having from 6 to 22 carbon atoms, especially long-chained esters of tartaric acid; fatty substances, for example fatty alcohols, fatty ketones, fatty aldehydes, fatty ethers and fatty carbonates, which in total have at least 24 carbon atoms, especially laurone and distearyl ether; fatty acids, such as stearic acid, hydroxystearic acid or behenic acid, ring-opening products of olefin epoxides having from 12 to 22 carbon atoms with fatty alcohols having from 12 to 22 carbon atoms and/or polyols having from 2 to 15 carbon atoms and from 2 to 10 hydroxy groups, and mixtures thereof.

### Hydrocarbon Oils:

Mineral oil (light or heavy), petrolatum (yellow or white), microcrystalline wax, paraffinic and isoparaffinic compounds, hydrogenated isoparaffinic molecules such as polydecenes and polybutene, hydrogenated polyisobutene, squalane, isohexadecane, isododecane and others of vegetable or animal origin.

### Silicones or Siloxanes (Organo-Substituted Polysiloxanes)

Dimethylpolysiloxanes, methylphenylpolysiloxanes, cyclic silicones, and also amino-, fatty acid-, alcohol-, polyether-, epoxy-, fluorine-, glycoside- and/or alkyl-modified silicone compounds, which at room temperature may be in either liquid or resinous form. Linear polysiloxanes, dimethicone (Dow Corning 200 fluid, Rhodia Mirasil DM), dimethiconol, cyclic silicone fluids, cyclopentasiloxane volatiles (Dow Corning 345 fluid), phenyltrimethicone (Dow Corning 556 fluid). Also suitable are simethicones, which are mixtures of dimethicones having an average chain length of from 200 to 300 dimethylsiloxane units with hydrogenated silicates. A detailed survey by Todd et al. of suitable volatile silicones may in addition be found in Cosm. Toil. 91, 27 (1976).

### Fluorinated or Perfluorinated Oils

Perfluorohexane, dimethylcyclohexane, ethylcyclopentane, polyperfluoromethylisopropyl ether.

### Emulsifiers

Any conventionally usable emulsifier can be used for the compositions. Emulsifier systems may comprise, for example: carboxylic acids and their salts: alkaline soaps of sodium, potassium and ammonium, metallic soaps of calcium or magnesium, organic-based soaps such as lauric, palmitic, stearic and oleic acid etc. Alkyl phosphates or phosphoric acid esters, acid phosphates, diethanolamine phosphate, potassium cetyl phosphate. Ethoxylated carboxylic acids or polyethylene glycol esters, PEG-n acylates. Linear fatty alcohols having from 8 to 22 carbon atoms, branched, from 2 to 30 mol of ethylene oxide and/or from 0 to 5 mol of propylene oxide with fatty acids having from 12 to 22 carbon atoms and with alkylphenols having from 8 to 15 carbon atoms in the alkyl group. Fatty alcohol polyglycol ethers such as laureth-n, ceteareth-n, steareth-n, oleth-n. Fatty acid polyglycol ethers such as PEG-n-stearate, PEG-n-oleate, PEG-n-cocoate. Monoglycerides and polyol esters. C₁₂—C₂₂ fatty acid mono- and di-esters of addition products of from 1 to 30 mol of ethylene oxide with polyols. Fatty acid and polyglycerol esters such as glycerol monostearate, diisostearoyl polyglyceryl-3-diisostearates, polyglyceryl-3-diisostearates, triglyceryl diisostearates, polyglyceryl-2-sesquiisostearates or polyglyceryl dimerates. Mixtures of compounds from a plurality of those substance classes are also suitable. Fatty acid polyglycol esters such as diethylene glycol monostearate, fatty acid and polyethylene glycol esters, fatty acid and saccharose esters such as sucrose esters, glycerol and saccharose esters such as sucrose glycerides. Sorbitol and sorbitan, sorbitan mono- and di-esters of saturated and unsaturated fatty acids having from 6 to 22 carbon atoms and ethylene oxide addition products. Polysorbate-n series, sorbitan esters such as sesquiisostearate, sorbitan, PEG-(6)-sorbitan isostearate, PEG-(10)-sorbitan laurate, PEG-17-sorbitan dioleate. Glucose derivatives, C₈—C₂₂alkyl-mono and oligo-glycosides and ethoxylated analogues with glucose being preferred as the sugar component. O/W emulsifiers such as methyl gluceth-20 sesquistearate, sorbitan stearate/sucrose cocoate, methyl glucose sesquistearate, cetearyl alcohol/cetearyl glucoside. W/O emulsifiers such as methyl glucose dioleate/methyl glucose isostearate. Sulfates and sulfonated derivatives, dialkylsulfosuccinates, dioctyl succinate, alkyl lauryl sulfonate, linear sulfonated paraffins, sulfonated tetrapropylene sulfonate, sodium lauryl sulfates, ammonium and ethanolamine lauryl sulfates, lauryl ether sulfates, sodium laureth sulfates, sulfosuccinates, acetyl isothionates, alkanolamide sulfates, taurines, methyl taurines, imidazole sulfates. Amine derivatives, amine salts, ethoxylated amines, oxiy amines with chains containing a heterocycle, such as alkyl imidazolines, pyridine derivatives, isoquinolines, cetylpyridinium chloride, cetylpyridinium bromide, quaternary ammonium such as cetyltrimethylammonium bromide (CTBA), stearylalkonium. Amide derivatives, alkanolamides such as acylamide DEA, ethoxylated amides such as PEG-n acylamide, oxydiamides. Polysiloxane/polyalkyl/polyether copolymers and derivatives, dimethicone, copolyols, silicone polyethylene oxide copolymer, silicone glycol copolymer. Propoxylated or POE-n ethers (Meroxapols), Polaxamers or poly(oxyethylene)m-block-poly(oxypropylene)n-block(oxyethylene). Zwitterionic surfactants that carry at least one quaternary ammonium group and at least one carboxylate and/or sulfonate group in the molecule. Zwitterionic surfactants that are especially suitable are betaines, such as N-alkyl-N,N-dimethylammonium glycinates, cocoalkyldimethylammonium glycinate, N-acylaminopropyl-N, N-dimethyl-ammonium glycinates, cocoacylaminopropyidimethylammonium glycinate and 2-alkyl-3-carboxymethyl-3-hydroxyethylimidazolines each having from 8 to 18 carbon atoms in the alkyl or acyl group and also cocoacylaminoethylhydroxyethylcarboxymethylglycinate, N-alkylbetaine, N-alkylaminobetaines. Alkylimidazolines, alkyl peptides, lipoamino acids, self-emulsifying bases and the compounds as described in K.F.DePolo, A short textbook of cosmetology, Chapter 8, Table 8-7, p 250-251.

Non-ionic emulsifiers such as PEG-6 beeswax (and) PEG-6 stearate (and) polyglyceryl 2-isostearate [Apifac], glyceryl stearate (and) PEG-100 stearate. [Arlacel 165], PEG-5 glyceryl stearate [Arlatone 983 S], sorbitan oleate (and) polyglyceryl-3 ricinoleate [Arlacel 1689], sorbitan stearate and sucrose cocoate [Arlatone 2121], glyceryl stearate and laureth- 23 [Cerasynth 945], cetearyl alcohol and Ceteth-20 [cetomacrogol wax], cetearyl alcohol and polysorbate 60 and PEG-150 and stearate-20 [polawax GP 200, polawax NF], cetearyl alcohol and cetearyl polyglucoside [Emulgade PL 1618], cetearyl alcohol and ceteareth-20 [Emulgade 1000 Nl, Cosmowax], cetearyl alcohol and PEG-40 castor oil [Emulgade F Special], cetearyl alcohol and PEG-40 castor oil and sodium cetearyl sulfate [Emulgade F], stearyl alcohol and steareth-7 and steareth-10 [Emulgator E 2155], cetearyl alcohol and steareth-7 and steareth-10 [emulsifying wax U.S.N.F], glyceryl stearate and PEG-75 stearate [Gelot 64], propylene glycol ceteth-3 acetate [Hetester PCS], propylene glycol isoceth-3 acetate [Hetester PHA], cetearyl alcohol and ceteth-12 and oleth-12 [Lanbritol Wax N21], PEG-6 stearate and PEG-32 stearate [Tefose 1500], PEG-6 stearate and ceteth-20 and steareth-20 [Tefose 2000], PEG-6 stearate and ceteth-20 and glyceryl stearate and steareth-20 [Tefose 2561], glyceryl stearate and ceteareth-20 [Teginacid H, C, X].

Anionic emulsifiers such as PEG-2 stearate SE, glyceryl stearate SE [Monelgine, Cutina KD], propylene glycol stearate [Tegin P], cetearyl alcohol and sodium cetearyl sulfate [Lanette N, Cutina LE, Crodacol GP], cetearyl alcohol and sodium lauryl sulfate [Lanette W], trilaneth-4 phosphate and glycol stearate and PEG-2 stearate [Sedefos 75], glyceryl stearate and sodium lauryl sulfate [Teginacid Special]. Cationic acid bases such as cetearyl alcohol and cetrimonium bromide.

The emulsifiers may be used in an amount of, for example, from 1 to 30 wt-%, especially from 4 to 20 wt-% and preferably from 5 to 10 wt-%, based on the total weight of the composition.

When formulated in O/W emulsions, the preferred amount of such emulsifier systems may constitute 5% to 20% of the oil phase.

### Adjuvants and Additives

The cosmetic/pharmaceutical preparations, for example creams, gels, lotions, alcoholic and aqueous/alcoholic solutions, emulsions, wax/fat compositions, stick preparations, powders or ointments, may in addition comprise, as further adjuvants and additives, mild surfactants, superfatting agents, consistency regulators, thickeners, polymers, stabilisers, biogenic active ingredients, deodorising active ingredients, anti-dandruff agents, film formers, swelling agents, UV-absorbers, antioxidants, hydrotropic agents, further preservatives, insect repellents, self-tanning agents, solubilisers, perfume oils, colorants, bacteria-inhibiting agents and the like.

### Superfatting Agents

Substances suitable for use as superfatting agents are, for example, lanolin and lecithin and also polyethoxylated or acrylated lanolin and lecithin derivatives, polyol fatty acid esters, monoglycerides and fatty acid alkanolamides, the latter simultaneously acting as foam stabilisers.

### Surfactants

Examples of suitable mild surfactants, that is to say surfactants especially well tolerated by the skin, include fatty alcohol polyglycol ether sulfates, monoglyceride sulfates, mono- and/or di-alkyl sulfosuccinates, fatty acid isothionates, fatty acid sarcosinates, fatty acid taurides, fatty acid glutamates, α-olefin sulfonates, ethercarboxylic acids, alkyl oligoglucosides, fatty acid glucamides, alkylamidobetaines and/or protein fatty acid condensation products, the latter preferably being based on wheat proteins.

### Consistency Regulators/Thickeners and Rheology Modifiers

Silicon dioxide, magnesium silicates, aluminium silicates, polysaccharides or derivatives thereof for example hyaluronic acid, xanthan gum, guar-guar, agar-agar, alginates, carragheenan, gellan, pectins, or modified cellulose such as hydroxycellulose, hydroxypropyl methylcellulose. In addition polyacrylates or homopolymers of crosslinked acrylic acids and polyacrylamides, carbomers (Carbopol types 980, 981, 1382, ETD 2001, ETD2020, Ultrez 10) or the Salcare range such as Salcare SC80 (steareth-10 allyl ether/acrylate copolymer), Salcare SC81 (acrylate copolymer), Salcare SC91 and Salcare AST (sodium acrylate copolymer/PPG-1 trideceth-6), Sepigel 305 (polyacrylamide/laureth-7), Simulgel NS and Simulgel EG (hydroxyethyl acrylate/sodium acryloyidimethyl taurate copolymer), Stabilen 30 (acrylate/vinyl isodecanoate crosspolymer), Pemulen TR-1 (acrylate/C₁₀—C₃₀alkyl acrylate crosspolymer), Luvigel EM (sodium acrylate copolymer), Aculyn 28 (acrylate/beheneth-25 methacrylate copolymer) etc.

### Polymers

Suitable cationic polymers are, for example, cationic cellulose derivatives, for example a quaternised hydroxymethyl cellulose obtainable under the name Polymer JR 400 from Amerchol, cationic starches, copolymers of diallylammonium salts and acrylamides, quaternised vinylpyrrolidone/vinyl imidazole polymers, for example Luviquat® (BASF), condensation products of polyglycols and amines, quaternised collagen polypeptides, for example lauryidimonium hydroxypropyl hydrolysed collagen (Lamequat®L/Gränau), quaternised wheat polypeptides, polyethyleneimine, cationic silicone polymers, for example amidomethicones, copolymers of adipic acid and dimethylaminohydroxypropyl diethylene-triamine (Cartaretin/Sandoz), copolymers of acrylic acid with dimethyidiallylammonium chloride (Merquat 550/Chemviron), polyaminopolyamides, as described, for example, in FR-A-2 252 840, and the crosslinked water-soluble polymers thereof, cationic chitin derivatives, for example of quaternised chitosan, optionally distributed as microcrystals; condensation products of dihaloalkyls, for example dibromobutane, with bisdialkylamines, for example bisdimethylamino-1,3-propane, cationic guar gum, for example Jaguar C-17, Jaguar C-16 from Celanese, quaternised ammonium salt polymers, for example Mirapol A-15, Mirapol AD-1, Mirapol AZ-1 from Miranol. As anionic, zwitterionic, amphoteric and non-ionic polymers there come into consideration, for example, vinyl acetate/crotonic acid copolymers, vinylpyrrolidone/vinyl acrylate copolymers, vinyl acetate/butyl maleate/isobornyl acrylate copolymers, methyl vinyl ether/maleic anhydride copolymers and esters thereof, uncross-linked polyacrylic acids and polyacrylic acids crosslinked with polyols, acrylamidopropyl-trimethylammonium chloride/acrylate copolymers, octyl acrylamide/methyl methacrylate-tert-butylaminoethyl methacrylate/2-hydroxypropyl methacrylate copolymers, polyvinyl-pyrrolidone, vinylpyrrolidone/vinyl acetate copolymers, vinylpyrrolidone/dimethylaminoethyl methacrylate/vinyl caprolactam terpolymers and also optionally derivatised cellulose ethers and silicones. Furthermore, the polymers as described in EP 1 093 796 (pages 3-8, paragraphs 17-68) may be used.

### Biogenic Active Ingredients

Biogenic active ingredients are to be understood as meaning, for example, tocopherol, tocopherol acetate, tocopherol palmitate, ascorbic acid, deoxyribonucleic acid, retinol, bisabolol, allantoin, phytantriol, panthenol, AHA acids, amino acids, ceramides, pseudoceramides, essential oils, plant extracts and vitamin complexes.

### Deodorising Active Ingredients

As deodorising active ingredients there come into consideration, for example, anti-perspirants, for example aluminium chlorohydrates (see J. Soc. Cosm. Chem. 24, 281 (1973)). Under the trade mark Locron® of Hoechst AG, Frankfurt (FRG), there is available commercially, for example, an aluminium chlorohydrate corresponding to formula Al₂(OH)₅Cl×2.5 H₂O, the use of which is especially preferred (see J. Pharm. Pharmacol. 26, 531 (1975)). Besides the chlorohydrates, it is also possible to use aluminium hydroxy- acetates and acidic aluminium/zirconium salts. Esterase inhibitors may be added as further deodorising active ingredients. Such inhibitors are preferably trialkyl citrates, such as trimethyl citrate, tripropyl citrate, triisopropyl citrate, tributyl citrate and especially triethyl citrate (Hydagen CAT, Henkel), which inhibit enzyme activity and hence reduce odour formation. Further substances that come into consideration as esterase inhibitors are sterol sulfates or phosphates, for example lanosterol, cholesterol, campesterol, stigmasterol and sitosterol sulfate or phosphate, dicarboxylic acids and esters thereof, for example glutaric acid, glutaric acid monoethyl ester, glutaric acid diethyl ester, adipic acid, adipic acid monoethyl ester, adipic acid diethyl ester, malonic acid and malonic acid diethyl ester and hydroxycarboxylic acids and esters thereof, for example citric acid, malic acid, tartaric acid or tartaric acid diethyl ester. Antibacterial active ingredients that influence the germ flora and kill or inhibit the growth of sweat-decomposing bacteria can likewise be present in the preparations (especially in stick preparations). Examples include chitosan, phenoxyethanol and chlorhexidine gluconate. 5-chloro-2-(2,4-dichlorophenoxy)-phenol (Triclosan, lrgasan, Ciba Specialty Chemicals Inc.) has also proved especially effective.

### Anti-Dandruff Agents

As anti-dandruff agents there may be used, for example, climbazole, octopirox and zinc pyrithione.

### Film Formers

Customary film formers include, for example, chitosan, microcrystalline chitosan, quaternised chitosan, polyvinylpyrrolidone, vinylpyrrolidone/vinyl acetate copolymers, polymers of quaternary cellulose derivatives containing a high proportion of acrylic acid, collagen, hyaluronic acid and salts thereof and similar compounds.

### Antioxidants

Typical examples of such antioxidants are amino acids (e.g. glycine, histidine, tyrosine, tryptophan) and derivatives thereof, imidazoles (e.g. urocanic acid) and derivatives thereof, peptides, such as D,L-carnosine, D-carnosine, L-carnosine and derivatives thereof (e.g. anserine), carotinoids, carotenes, lycopene and derivatives thereof, chlorogenic acid and derivatives thereof, lipoic acid and derivatives thereof (e.g. dihydrolipoic acid), aurothioglycose, propylthiouracil and other thiols (e.g. thioredoxin, glutathione, cysteine, cystine, cystamine and the glycosyl, N-acetyl, methyl, ethyl, propyl, amyl, butyl, lauryl, palmitoyl, oleyl, linoleyl, cholesteryl and glyceryl esters thereof) and also salts thereof, dilauryl thiodipropionate, distearyl thiodipropionate, thiodipropionic acid and derivatives thereof (esters, ethers, peptides, lipids, nucleotides, nucleosides and salts) and also sulfoximine compounds (e.g. buthionine sulfoximines, homocysteine sulfoximine, buthionine sulfones, penta-, hexa-, hepta-thionine sulfoximine), also (metal) chelating agents (e.g. hydroxy fatty acids, palmitic acid, phytic acid, lactoferrin), hydroxy acids (e.g. citric acid, lactic acid, malic acid), humic acid, bile acid, bile extracts, bilirubin, biliverdin, EDTA, EDDS, EGTA and derivatives thereof, unsaturated fatty acids and derivatives thereof (e.g. linolenic acid, linoleic acid, oleic acid), folic acid and derivatives thereof, ubiquinone and ubiquinol and derivatives thereof, vitamin C and derivatives (e.g. ascorbyl palmitate, magnesium ascorbyl phosphate, ascorbyl acetate), tocopherols and derivatives (e.g. vitamin E acetate), vitamin A and derivatives (e.g. vitamin A palmitate) and also coniferyl benzoate of benzoin resin, rutinic acid and derivatives thereof, glycosylrutin, ferulic acid, furfurylidene glucitol, carnosine, butyl hydroxytoluene, butyl hydroxyanisole, nordihydroguaiaretic acid, trihydroxybutyrophenone, uric acid and derivatives thereof, mannose and derivatives thereof, superoxide dismutase, N-[3-(3,5-di-tert-butyl-4-hydroxyphenyl)propionyl]sulfanilic acid (and salts thereof, for example the disodium salts), zinc and derivatives thereof (e.g. ZnO, ZnSO₄), selenium and derivatives thereof (e.g. selenium methionine), stilbene and derivatives thereof (e.g. stilbene oxide, trans-stilbene oxide) and the derivatives suitable according to the invention (salts, esters, ethers, sugars, nucleotides, nucleosides, peptides and lipids) of those mentioned active ingredients. HALS (=“Hindered Amine Light Stabilizers”) compounds may also be mentioned. Further synthetic and natural antioxidants are listed e.g. in patent WO 0025731: structures 1-3 (page 2), structure 4 (page 6), structures 5-6 (page 7) and compounds 7-33 (page 8-14).

The amount of antioxidants present is usually from 0.001 to 30 wt-%, preferably from 0.01 to 3 wt-%.

### Hydrotropic Agents

To improve the flow behaviour it is also possible to employ hydrotropic agents, for example ethoxylated or non ethoxylated mono-alcohols, diols or polyols with a low number of carbon atoms or their ethers (e.g. ethanol, isopropanol, 1,2-dipropanediol, propylene glycol, glycerol, ethylene glycol, ethylene glycol monoethyl ether, ethylene glycol monobutyl ether, propylene glycol monomethyl ether, propylene glycol monoethyl ether, propylene glycol monobutyl ether, diethylene glycol monomethyl ether; diethylene glycol monoethyl ether, diethylene glycol monobutyl ether and similar products). The polyols that come into consideration for that purpose have preferably from 2 to 15 carbon atoms and at least two hydroxy groups. The polyols may also contain further functional groups, especially amino groups, and/or may be modified with nitrogen. Typical examples are as follows: glycerol, alkylene glycols, for example ethylene glycol, diethylene glycol, propylene glycol, butylene glycol, hexylene glycol and also polyethylene glycols having an average molecular weight of from 100 to 1000 Dalton; technical-grade oligoglycerol mixtures having an intrinsic degree of condensation of from 1.5 to 10, for example technical-grade diglycerol mixtures having a diglycerol content of from 40 to 50% by weight; methylol compounds, such as, especially, trimethylolethane, trimethylolpropane, trimethylolbutane, pentaerythritol and dipentaerythritol; lower alkyl-glucosides, especially those having from 1 to 8 carbon atoms in the alkyl radical, for example methyl and butyl glucoside; sugar alcohols having from 5 to 12 carbon atoms, for example sorbitol or mannitol; sugars having from 5 to 12 carbon atoms, for example glucose or saccharose; amino sugars, for example glucamine; dialcohol amines, such as diethanol-amine or 2-amino-1,3-propanediol.

### Other Preservatives and Bacteria-Inhibiting Agents

Other preservatives can include, for example, methyl, ethyl, propyl and butyl parabens, benzalkonium chloride, 2-bromo-2-nitro-propane-1,3-diol, dehydroacetic acid, diazolidinyl urea, 2-dichloro-benzyl alcohol, DMDM hydantoin, formaldehyde solution, methyidibromo-glutanitrile, phenoxyethanol, sodium hydroxymethylglycinate, imidazolidinyl urea, triclosan and further substance classes listed in the following reference: K.F.DePolo—A short textbook of cosmetology, Chapter 7, Table 7-2, 7-3, 7-4 and 7-5, p 210-219.

### Perfume Oils

There may be mentioned as perfume oils mixtures of natural and/or synthetic aromatic substances. Natural aromatic substances are, for example, extracts from blossom (lilies, lavender, roses, jasmine, neroli, ylang-ylang), from stems and leaves (geranium, patchouli, petitgrain), from fruit (aniseed, coriander, carraway, juniper), from fruit peel (bergamot, lemons, oranges), from roots (mace, angelica, celery, cardamom, costus, iris, calmus), from wood (pinewood, sandalwood, guaiacum wood, cedarwood, rosewood), from herbs and grasses (tarragon, lemon grass, sage, thyme), from needles and twigs (spruce, pine, Scots pine, mountain pine), from resins and balsams (galbanum, elemi, benzoin, myrrh, olibanum, opoponax). Animal raw materials also come into consideration, for example civet and castoreum. Typical synthetic aromatic substances are, for example, products of the ester, ether, aldehyde, ketone, alcohol or hydrocarbon type. Aromatic substance compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals having from 8 to 18 hydrocarbon atoms, citral, citronellal, citronellyl oxyacetaldehyde, cyclamen aldehyde, hydroxycitronellal, lilial and bourgeonal; the ketones include, for example, the ionones, isomethylionone and methyl cedryl ketone; the alcohols include, for example, anethol, citronellol, eugenol, isoeugenol, geraniol, linalool, phenyl ethyl alcohol and terpinol; and the hydrocarbons include mainly the terpenes and balsams. It is preferable, however, to use mixtures of various aromatic substances that together produce an attractive scent. Ethereal oils of relatively low volatility, which are chiefly used as aroma components, are also suitable as perfume oils, e.g. sage oil, camomile oil, clove oil, melissa oil, oil of cinnamon leaves, lime blossom oil, juniper berry oil, vetiver oil, olibanum oil, galbanum oil, labdanum oil and lavandin oil. Preference is given to the use of bergamot oil, dihydromyrcenol, lilial, lyral, citronellol, phenyl ethyl alcohol, hexyl cinnamaldehyde, geraniol, benzyl acetone, cyclamen aldehyde, linalool, boisambrene forte, ambroxan, indole, hedione, sandelice, lemon oil, tangerine oil, orange oil, allyl amyl glycolate, cyclovertal, lavandin oil, muscatel sage oil, damascone, bourbon geranium oil, cyclohexyl salicylate, vertofix coeur, iso-E-Super, Fixolide NP, evernyl, iraldein gamma, phenylacetic acid, geranyl acetate, benzyl acetate, rose oxide, romillat, irotyl and floramat alone or in admixture with one another.

### Colorants

There may be used as colorants the substances that are suitable and permitted for cosmetic purposes, as compiled, for example, in the publication “Kosmetische Färbemittel” of the Farbstoffkommission der Deutschen Forschungsgemeinschaft, Verlag Chemie, Weinheim, 1984, pages 81 to 106. The colorants are usually used in concentrations of from 0.001 to 0.1 wt-%, based on the total mixture.

### Other Adjuvants

It is furthermore possible for the cosmetic preparations to comprise, as adjuvants, anti-foams, such as silicones, structurants, such as maleic acid, solubilisers, such as ethylene glycol, propylene glycol, glycerol or diethylene glycol, opacifiers, such as latex, styrene/PVP or styrene/acrylamide copolymers, complexing agents, such as EDTA, NTA, alaninediacetic acid or phosphonic acids, propellants, such as propane/butane mixtures, N₂O, dimethyl ether, CO₂, N₂ or air, so-called coupler and developer components as oxidation dye precursors, reducing agents, such as thioglycolic acid and derivatives thereof, thiolactic acid, cysteamine, thiomalic acid or mercaptoethanesulfonic acid, or oxidising agents, such as hydrogen peroxide, potassium bromate or sodium bromate.

Suitable insect repellents are, for example, N,N-diethyl-m-toluamide, 1,2-pentanediol or insect repellent 3535; suitable self-tanning agents are, for example, dihydroxyacetone and/or erythrulose or dihydroxy acetone and/or dihydroxy acetone precursors as described in WO 01/85124 and/or erythrulose.

1. A method of preserving a pharmaceutical, cosmetic, and/or personal care formulation comprising incorporating into said formulation an effective preserving amount of a compound of the following formula (1) 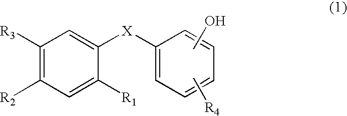
wherein
X is —CH₂— or —O—;
R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;
R₃ is hydrogen, C₁-C₂₀alkyl, C₁-C₆alkylcarbonyl or C₁-C₂₀alkoxy; and
R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl.

2. A method according to claim 1, wherein
X is —CH₂— or —O—
R₁ and R₂ are independently of each other hydrogen, hydroxy, C₁-C₁₀alkyl, C₅-C₇cycloalkyl, C₁-C₄alkylcarbonyl, C₁-C₁₀alkoxy, phenyl or phenyl-C₁-C₃-alkyl;
R₃ is hydrogen, C₁-C₁₀alkyl, C₁-C₄alkylcarbonyl or C₁-C₁₀alkoxy;
R₄ is hydrogen, C₁-C₁₀alkyl, hydroxy substituted C₁-C₁₀alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl.

3. A method according to claim 1, wherein
X is —CH₂— or —O—
R₁ and R₂ are independently of each other hydrogen, hydroxy, C₁-C₄alkyl, C₅-C₇cycloalkyl, C₁-C₄alkylcarbonyl, C₁-C₄alkoxy, phenyl or phenyl-C₁-C₃-alkyl;
R₃ is hydrogen, C₁-C₄alkyl, C₁-C₄alkylcarbonyl or C₁-C₄alkoxy;
R₄ is hydrogen, C₁-C₄alkyl, hydroxy substituted C₁13 C₄alkyl, C₅-C₇cycloalkyl, hydroxy, formyl, acetonyl, C₁-C₄alkylcarbonyl, C₂-C₁₀alkenyl, carboxy, carboxyC₁-C₃alkyl, C₁-C₃alkylcarbonylC₁-C₃alkyl or carboxyallyl.

4. A method according to claim 1, wherein a compound of formula (1a), 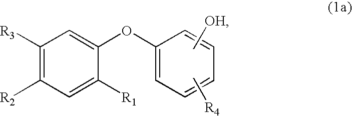
wherein
R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;
R₃ is hydrogen, C₁-C₂₀alkyl, C₁-C₆alkylcarbonyl or C₁-C₂₀alkoxy;
R₄ is hydrogen, C₁-C₂₀alkyl, hydroxy substituted C₁-C₂₀alkyl, C₅-C₇cycloalkyl, hydroxy, formyl, acetonyl, C₁—C₆alkylcarbonyl, C₂-C₂₀alkenyl, carboxy, carboxyC₁-C₃alkyl, C₁13 ₃alkylcarbonylC₁-C₃alkyl or carboxyallyl,
is used.

5. A method according to claim 1, wherein a compound of formula (1b), 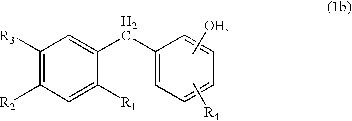
wherein
R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;
R₃ is hydrogen, C₁-C₂₀alkyl, C₁-C₆alkylcarbonyl or C₁-C₂₀alkoxy;
R₄ is hydrogen, C₁-C₂₀alkyl, hydroxy substituted C₁-C₂₀alkyl, C₅-C₇cycloalkyl, hydroxy, formyl, acetonyl, C₁-C6alkylcarbonyl, C₂-C₂₀alkenyl, carboxy, carboxyC₁-C₃alkyl, C₁-C₃alkylcarbonylC₁-C₃alkyl or carboxyallyl,
is used.

6. A method according to claim 1, wherein a compound of formula (1c), 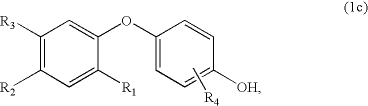
wherein
R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;
R₃ is hydrogen, C₁-C₂₀alkyl, C₁-C₆alkylcarbonyl or C₁-C₂₀alkoxy;
R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;
is used.

7. A method according to claim 1, wherein a compound of formula (1d), 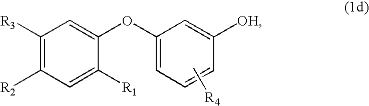
wherein
R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;
R₃ is hydrogen, C₁-C₂₀alkyl, C₁-C₆alkylcarbonyl or C₁-C₂₀alkoxy;
R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;
is used.

8. A method according to claim 1, wherein a compound of formula (1e), 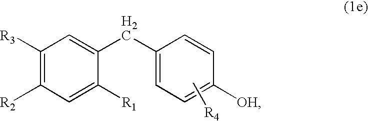
wherein
R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;
R₃ is hydrogen, C₁-C₂₀alkyl, C₁-C₆alkylcarbonyl or C₁-C₂₀alkoxy;
R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;
is used.

9. A method according to claim 1, wherein a compound of formula (1f), 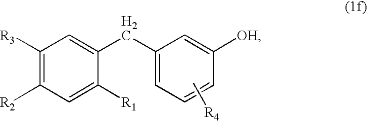
wherein
R₁ and R₂ are independently of each other hydrogen, hydroxy, C₁-C₂₀alkyl, C₅-C₇cycloalkyl, C₁-C₆alkylcarbonyl, C₁-C₂₀alkoxy, phenyl or phenyl-C₁-C₃-alkyl;
R₃ is hydrogen, C₁-C₂₀alkyl, C₁-C₆alkylcarbonyl or C₁-C₂₀alkoxy;
R₄ is hydrogen, C₁-C₂₀alkyl, hydroxy substituted C₁-C₂₀alkyl, C₅-C₇cycloalkyl, hydroxy, formyl, acetonyl, C₁-C₆alkylcarbonyl, C₂-C₂₀alkenyl, carboxy, carboxyC₁-C₃alkyl, C₁-C₃alkylcarbonylC₁-C₃alkyl or carboxyallyl;
is used.

10. A method according to claim 1, wherein a compound of formula (1g) 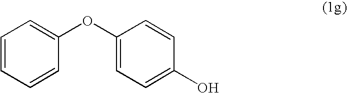
is used.

11. A method according to claim 1, wherein a compound of formula (1h) 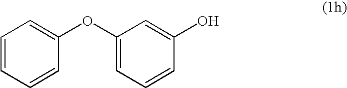
is used.

12. A method according to claim 1, wherein a compound of formula (1i) 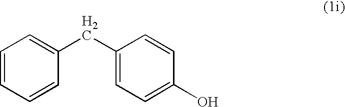
is used.

13. A method according to claim 1 wherein at least one compound of formula (1), (1a), (1b), (1c), (1d), (1e), (1f), (1g), (1h) and/or (1i) is incorporated into the cosmetic and/or pharmaceutical formulations.

14. (canceled)

15. A personal care formulation comprising at least one compound of formula (1), (1a), (1b), (1c), (1d), (1e), (1f), (1g), (1h) and/or (1i) according to claim 1.

16. A personal care formulation according to claim 15 comprising 0.01 and about 5 wt-% of at least one compound of formula (1), (1a), (1b), (1c), (1d), (1e), (1f), (1g), (1h) and/or (1i).

17. A pharmaceutical formulation comprising at least one compound of formula (1), (1a), (1b), (1c), (1d), (1e), (1f), (1g), (1h) and/or (1i) according to claim 1.

18. A pharmaceutical formulation according to claim 17 comprising 0.01 and about 5 wt-% of at least one compound of formula (1), (1a), (1b), (1c), (1d), (1e), (1f), (1g), (1h) and/or (1i).
